(19) United States
(12) Patent Application Publication
(10) Pub. No.: US 2019/0078598 A1
(43) Pub. Date: Mar. 14, 2019

(54) PANEL LOCK CONSTRUCT

(71) Applicant: Central Graphics and Container Group Ltd., Mississauga (CA)

(72) Inventors: Jamie Bogdanovich, Woodbridge (CA); Joel Pollock, Toronto (CA)

(21) Appl. No.: 16/129,028

(22) Filed: Sep. 12, 2018

Related U.S. Application Data
(60) Provisional application No. 62/557,791, filed on Sep. 13, 2017.

(30) Foreign Application Priority Data
Sep. 12, 2017 (CA) 2978912

(51) Int. Cl. F16B 5/00; F16B 5/01

(52) U.S. Cl. CPC F16B 5/0036; F16B 2005/0678; F16B 5/0008; F16B 5/01

(57) ABSTRACT

A construct and kit are provided including a pair of panels, each of the panels having a planar surface surrounded by an outer edge, one of the pair of panels defining a void in which a female component of a coffin lock is situated, the female component defining a cavity with a pin extending thereacross, the cavity presenting outwardly from the one of the pair of panels, and the other of the pair of panels defining another void at the outer edge of the other of the pair of panels in which a male component is situated, the male component defining another cavity presenting outwardly from the outer edge of the other of the pair of panels, the other cavity having a hook extending therefrom and protruding from the outer edge, wherein the hook of the male component is releasably engageable with the pin of the female component.

### CROSS-REFERENCE TO RELATED APPLICATIONS

This application claims priority to U.S. Provisional Patent Application Ser. No. 62/557,791, filed Sep. 13, 2017 and Canadian Patent Application No. 2978912 filed Sep. 12, 2017.

### BACKGROUND OF THE INVENTION

### 1. Field of the Invention

The present invention relates to the field of corrugated constructs.

### 2. Prior Art

Composite structural components including composite boards utilizing honeycomb centers have been disclosed in the art, such as that disclosed in U.S. patent application Ser. No. 15/473,253, which is herein incorporated by reference. A manner in which such panels may be joined or locked together for temporary hoarding, constructing walls, retail displays, trade show booths and/or furniture with relative ease is desirable.

### SUMMARY OF THE INVENTION

This disclosure provides a construct comprising a plurality of corrugated panels, the plurality including a pair of panels, each of the panels having a planar surface surrounded by an outer edge, one of the pair of panels defining a void in which a female component of a coffin lock is situated, the female component defining a cavity with a pin extending thereacross, the cavity presenting outwardly from the one of the pair of panels, and the other of the pair of panels defining another void at the outer edge of the other of the pair of panels in which a male component is situated, the male component defining another cavity presenting outwardly from the outer edge of the other of the pair of panels, the other cavity having a hook extending therefrom and protruding from the outer edge, wherein the hook of the male component is releasably engaged with the pin of the female component, thereby locking the pair of panels together.

This disclosure further provides a kit comprising a plurality of corrugated panels, the plurality including a pair of panels, each of the panels having a planar surface surrounded by an outer edge, one of the pair of panels defining a void in which a female component of a coffin lock is situated, the female component defining a cavity with a pin extending thereacross, the cavity presenting outwardly from the one of the pair of panels, and the other of the pair of panels defining another void at the outer edge of the other of the pair of panels in which a male component is situated, the male component defining another cavity presenting outwardly from the outer edge of the other of the pair of panels, the other cavity having a hook extendable therefrom for releasably engaging with the pin of the female component and locking the pair of panels together.

This disclosure further provides a panel comprising a corrugated body having a planar surface surrounded by an outer edge, a female component of a coffin lock secured within a void in the corrugated body, the female component defining a cavity with a pin extending thereacross, the cavity presenting outwardly from the corrugated body, and a male component of the coffin lock secured within another void in the corrugated body, the male component defining another cavity presenting outwardly from the outer edge of the corrugated body, the other cavity having a hook extendable therefrom for releasably engaging with another pin of another female component.

Advantages and features of the invention will become evident upon a review of the following detailed description and the appended drawings, the latter being briefly described hereinafter.

### BRIEF DESCRIPTION OF THE DRAWINGS

Reference will now be made to the accompanying drawings and in which:

FIG. 1 is an exploded view of a coffin lock including a male component and a female component according to an embodiment of the invention;

FIG. 2 is a front elevation view of a panel with the internal female component shown in dashed lines according to another embodiment of the present invention;

FIG. 3 is a side elevation view of the panel of FIG. 2 without showing the internal structure;

FIG. 4 is a view of the panel of FIG. 3 with edge banding removed;

FIG. 5 is a front elevation view of a panel with the internal male component shown in dashed lines according to another embodiment of the present invention;

FIG. 6 is a side elevation view of the panel of FIG. 5 without showing the internal structure;

FIG. 7 is a view of the panel of FIG. 6 with edge banding removed;

FIG. 8 is an upper perspective view of a construct with the internal coffin lock shown in dashed lines according to another embodiment of the present invention;

FIG. 9 is an upper perspective view of a kit according to another embodiment of the present invention;

FIG. 10 is an upper perspective view of a construct with the internal coffin lock shown in dashed lines according to another embodiment of the present invention;

FIG. 11 is an upper perspective view of a kit without showing the internal structure according to another embodiment of the present invention;

FIG. 12 is an upper perspective view of a panel with internal male and female components shown in dashed lines according to another embodiment of the present invention;

FIG. 13 is an upper perspective view of a kit without showing the internal structure according to another embodiment of the present invention;

FIG. 14 is a view of a workstation which forms another embodiment of the present invention;

FIG. 15 is a view of a retail display which forms another embodiment of the present invention;

FIG. 16 is a view of an office space which forms another embodiment of the present invention;

FIG. 17 is a view of a trade show booth which forms another embodiment of the present invention;

FIG. 18 is a view of a desk which forms another embodiment of the present invention;

FIG. 19 is a view of a retail display which forms another embodiment of the present invention;

FIG. 20 is a view of a retail display which forms another embodiment of the present invention;

FIG. 21 is a view of a shelving unit which forms another embodiment of the present invention;

FIG. 22 is a view of a closet which forms another embodiment of the present invention; and

FIG. 23 is a view of temporary hoarding which forms another embodiment of the present invention.

### DETAILED DESCRIPTION OF THE PREFERRED EMBODIMENTS

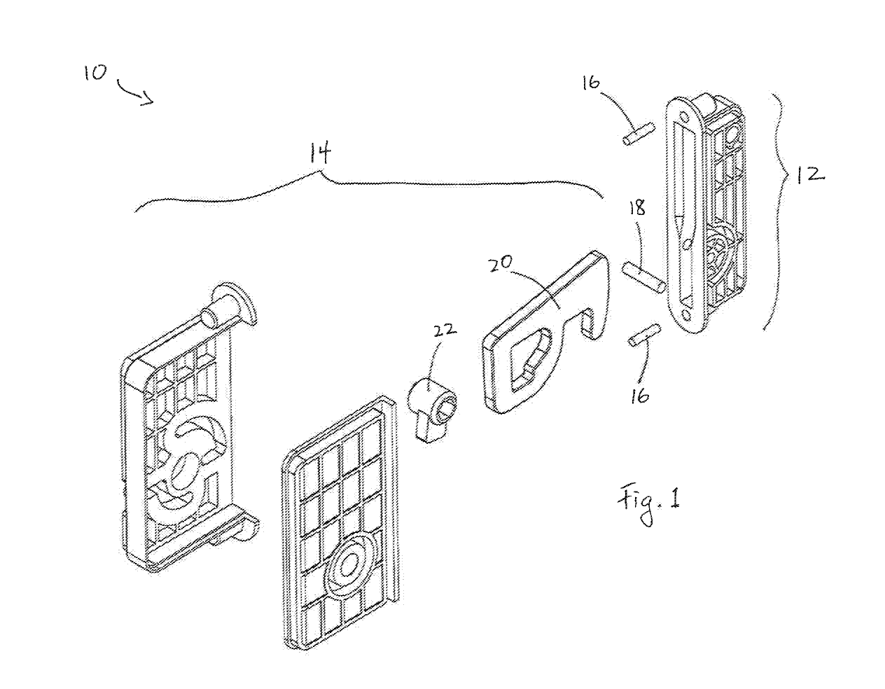

An example embodiment of the present invention showing a coffin lock 10 incorporated within a pair of panels 30, 40 will be described. As seen in FIG. 1, coffin lock 10 in the present embodiment comprises a female component 12, a male component 14, and alignment pins 16. Panels 30 and 40 will each be described in turn.

As seen in FIGS. 2-4, one of the pair of panels 30 is shown having female component 12 of coffin lock 10 incorporated therein. Panel 30 has a planar surface 32 surrounded by an outer edge 34. In the depicted embodiment, panel 30 includes edge banding 36 at outer edge 34. Edge banding 36 is typically fixed in place using EVA glue. Panel 30 further defines a void in which female component 12 of coffin lock 10 is situated. Viewed without the edge banding, as seen in FIG. 4, panel 30 includes a central honeycomb layer 50 flanked by a pair of corrugated layers 52. The void in which female component 12 is situated is thus defined within honeycomb layer 50 and extends between corrugated layers 52 in panel 30. In the present embodiment, panel 30 is made from corrugated cardboard. Honeycomb layer 50 in panel 30 is generally 1⅛ inches thick and each of the pair of corrugated layers 52 is generally % inches thick.

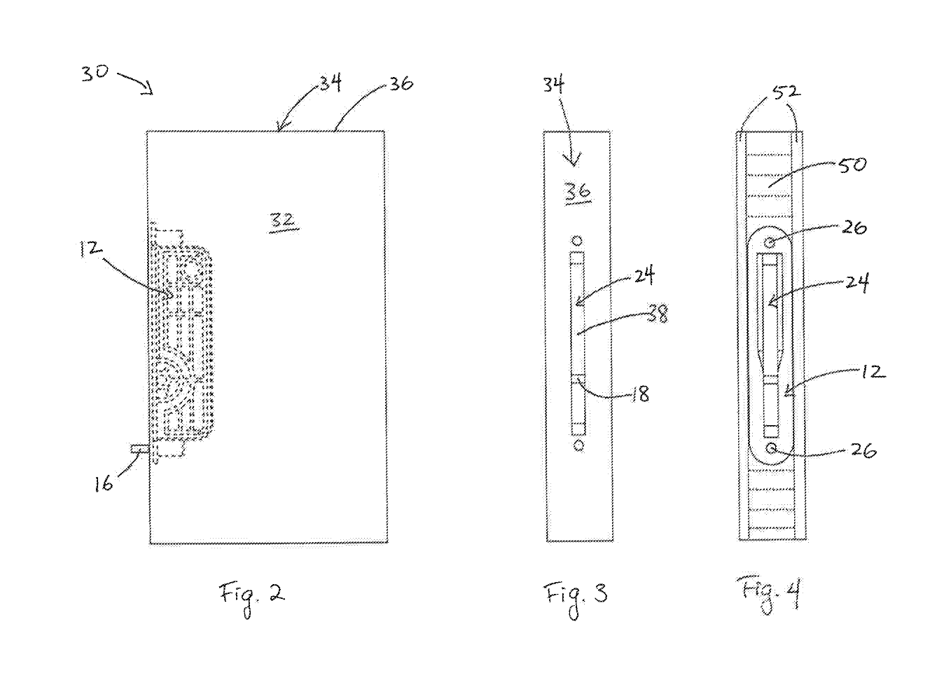

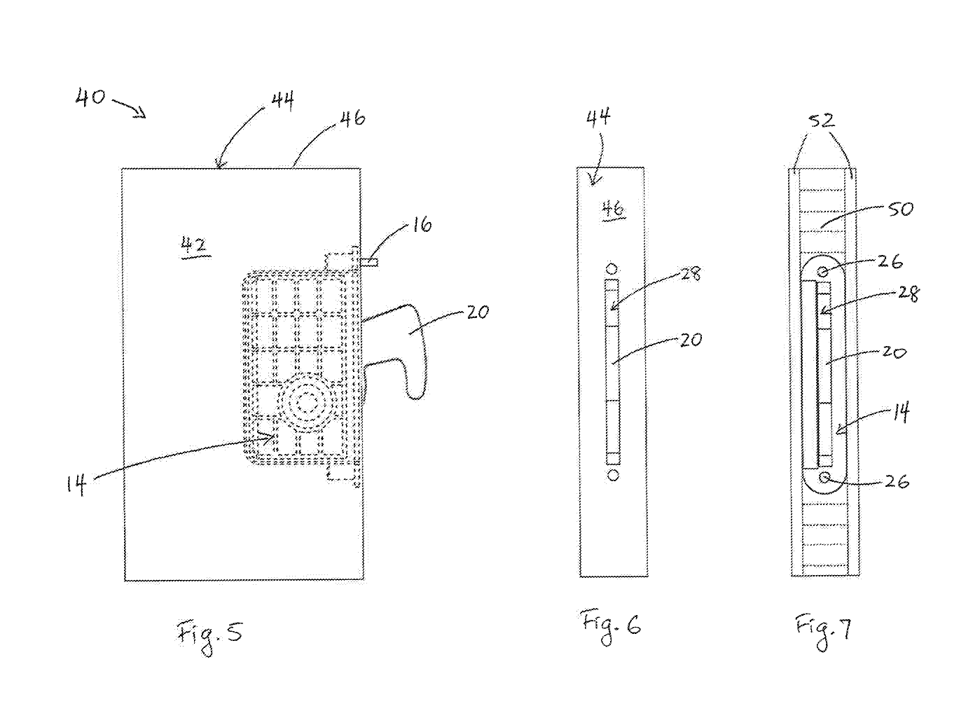

Female component 12 is fixed within panel 30 using PUR glue. Female component 12 defines a cavity 24 with a pin 18 extending across cavity 24. As best seen in FIG. 3, female component 12 is also situated within panel 30 such that cavity 24 presents outwardly from outer edge 34 of panel 30. In this manner, edge banding 36 then also defines an aperture 38 in communication with cavity 24 of female component 12. Female component 12 further defines a pair of alignment apertures 26 flanking cavity 24. Alignment apertures 26 are configured to receive alignment pin 16 therethrough. As such, edge banding 36 further also defines apertures in communication with alignment apertures 26 of female component 12.

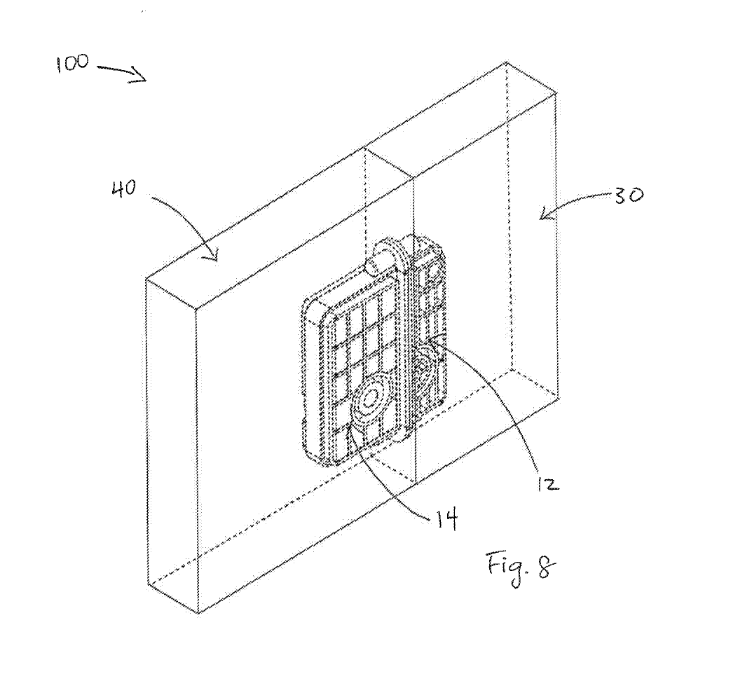

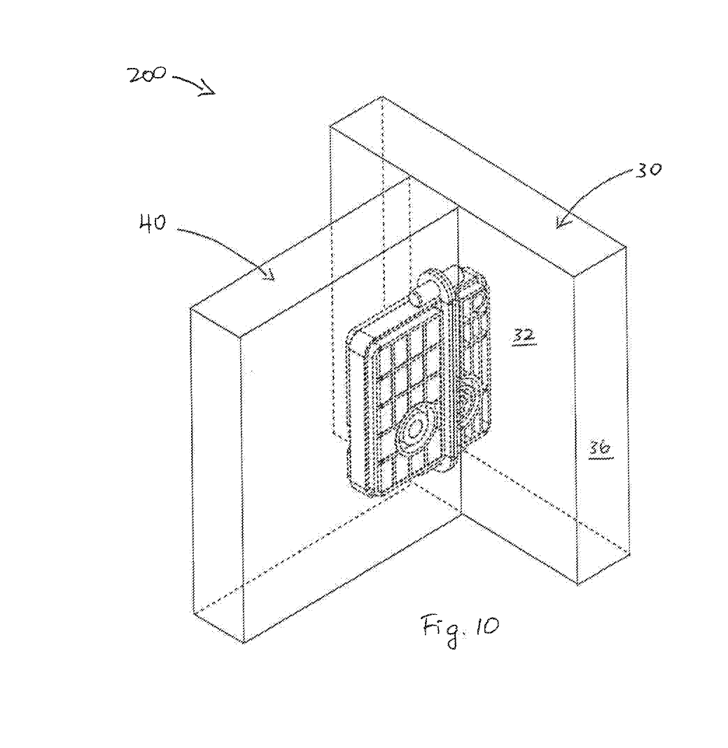

As seen in FIGS. 5-7, the other of the pair of panels 40 is shown having male component 14 of coffin lock 10 incorporated therein. In the depicted embodiment, other panel 40 has a planar surface 42 surrounded by an outer edge 44 and edge banding 46 at outer edge 44. Other panel 40 further defines a void in which male component 14 of coffin lock 10 is situated. Viewed without the edge banding, in like manner with panel 30, other panel 40 includes central honeycomb layer 50 flanked by corrugated layers 52 (see FIG. 7). The void in which male component 14 is situated is thus defined within honeycomb layer 50 and extends between corrugated layers 52 in panel 40. In the present embodiment, panel 40 is made from corrugated cardboard. Honeycomb layer 50 in other panel 40 is generally 1⅛ inches thick and each of the pair of corrugated layers 52 is generally ⅜ inches thick.

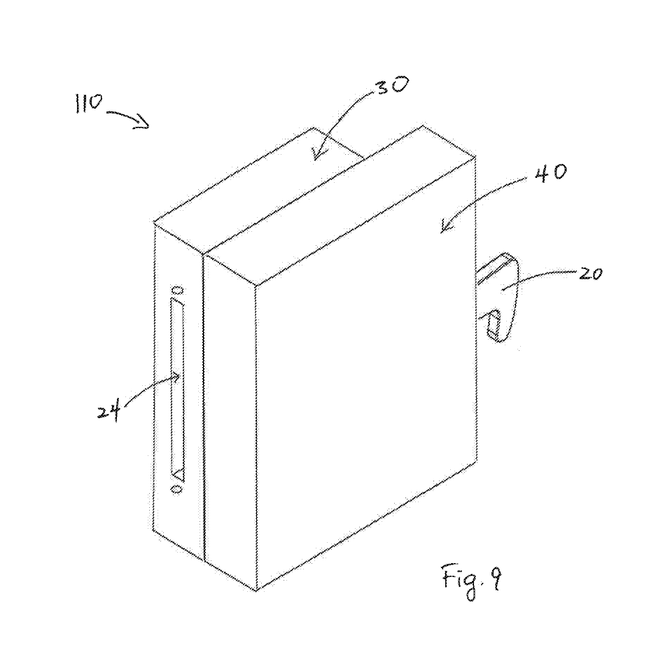

Male component 14 includes a cam actuator 22 and a hook 20 operatively coupled to cam actuator 22. Male component 12 defines another cavity 28 from which hook 20 extends. As best seen in FIG. 6, male component 14 is also situated within other panel 40 such that other cavity 28 presents outwardly from outer edge 44 of panel 40. In this manner, edge banding 46 then also defines another aperture 48 in communication with other cavity 28 of male component 14 such that hook 20 protrudes from outer edge 44. Male component 14 further defines alignment apertures 26 flanking other cavity 28. Alignment apertures 26 are configured to receive alignment pin 16 therethrough. As such, edge banding 46 further also defines apertures in communication with alignment apertures 26 of male component 14.

According to an embodiment of the present invention, panel 30 and other panel 40 is used in a construct 100 or is included in a kit 110.

With construct 100, when hook 20 of male component 14 is releasably engaged with pin 18 of female component 12, panels 30 and 40 are locked together, as seen in FIG. 8. Since cavity 24 of female component 12 presents outwardly from outer edge 34 of panel 30, panels 30 and 40 are locked together generally to form a common plane or a larger panel.

As noted above, the male and female components each define alignment apertures 26. Alignment apertures 26 are situated on their respective component to be complementary with one another. As such, construct 100 further includes alignment pins 16 received through alignment apertures 26 in both male and female components 12 and 14. Alignment pins 16 guide male and female components 12 and 14 into alignment prior to locking the pair of panels together into construct 100.

In this manner, a plurality of panels as described may be joined together to form a number of different structures for a number of different purposes, including temporary hoarding, walls of a trade show booth and retail displays. Construct 100 may also be used to hold freezer room panels together.

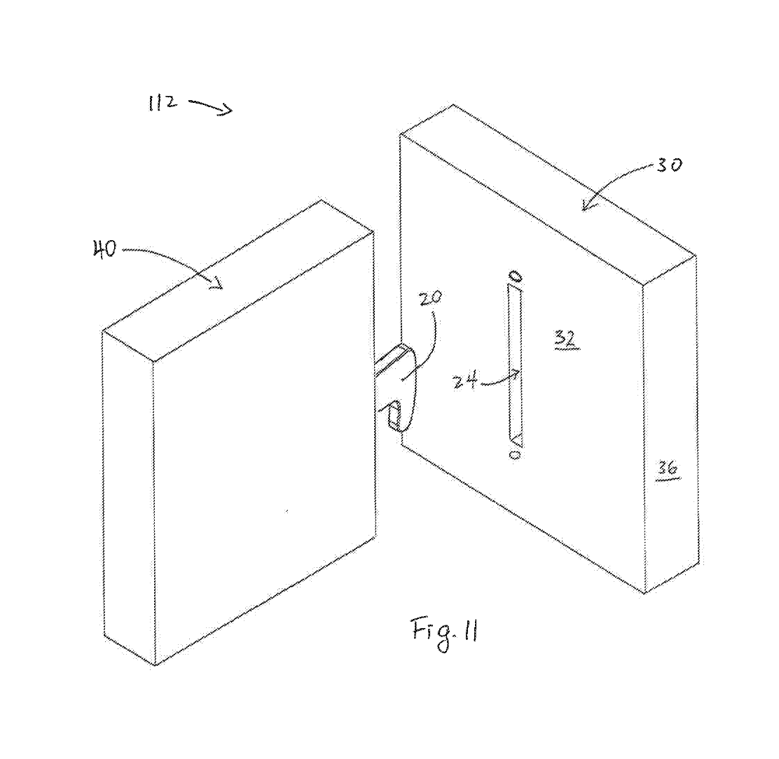

Panels 30 and 40 is also used in kit 110 as seen in FIG. 9, where panels 30 and 40 are simply packed in pieces in a box for shipment.

Whereas a specific embodiment is herein shown and described, variations are possible.

In an example, rather than presenting outwardly from outer edge 34 of panel 30, cavity 24 of female component 12 may present outwardly from planar surface 32 of panel 30, as seen in alternative construct 200 in FIG. 10 and as seen in alternative kit 112 in FIG. 11. In this manner, the panels may be locked together perpendicular to one another. As would be understood by one skilled in the art, the panels may otherwise be locked together at any angle relative to one another.

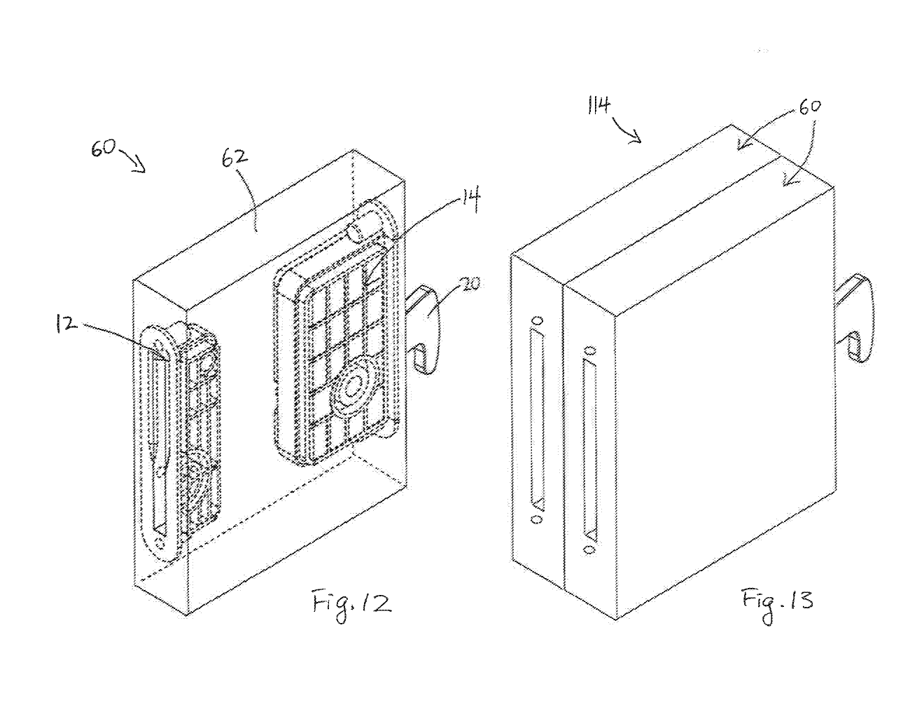

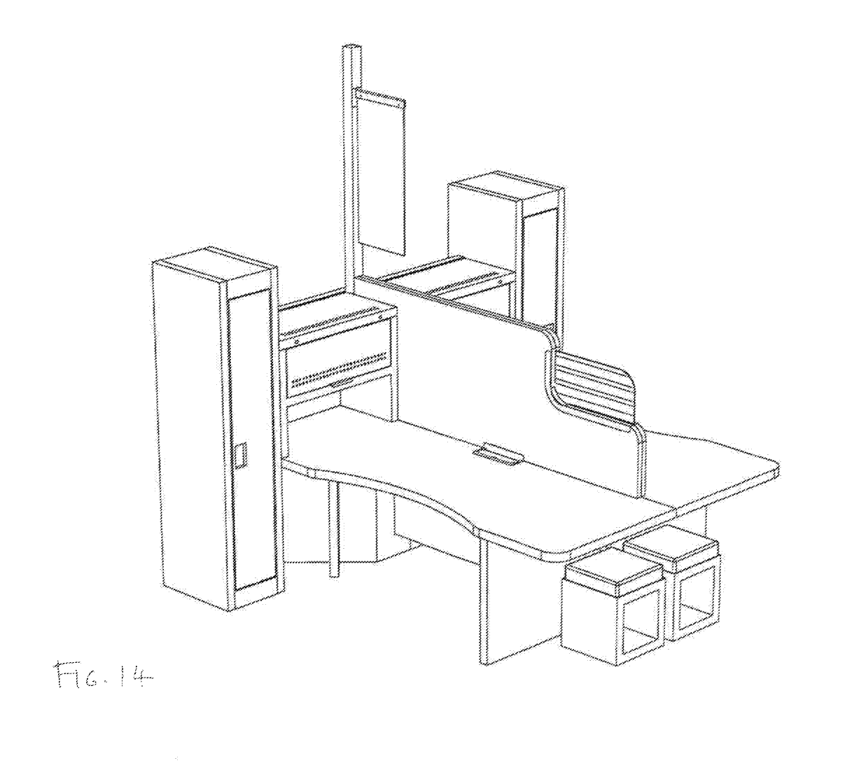

In another example, rather than each panel comprising a single component of coffin lock 10, an alternative panel may include multiple components of coffin lock 10. For example, as shown in FIG. 12, alternative panel 60 includes both female and male components 12 and 14 housed in a corrugated body 62. In similar manner as panels 30 and 40, corrugated body 62 is made from corrugated cardboard and also includes a planar surface and an outer edge that are bound by edge banding. In the embodiment shown, the cavities of both female component 12 and male component 14 present outwardly from the outer edge of alternative panel 60. As before, the cavity of female component 12 may instead present outwardly from the planar surface of alternative panel 60.

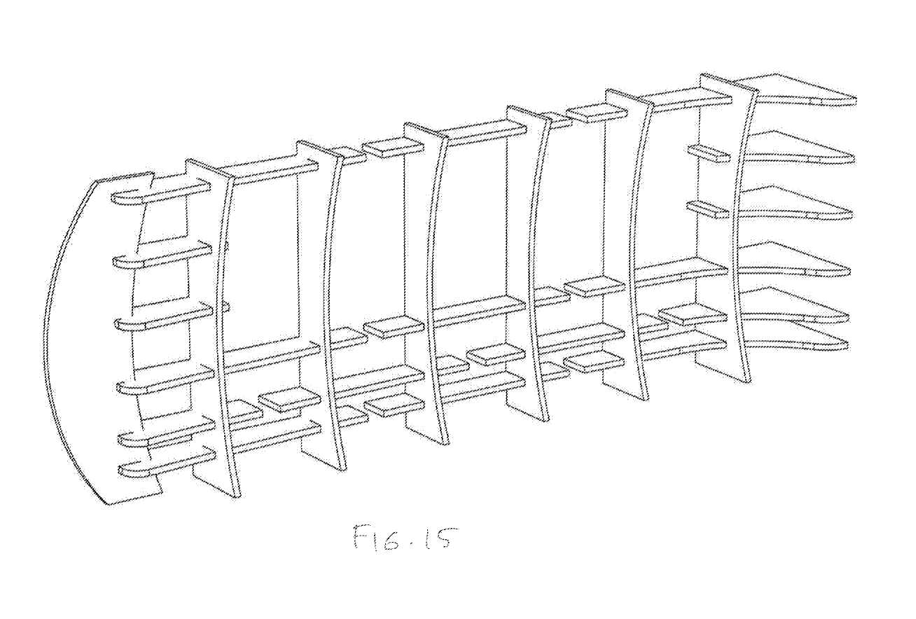

A further alternative kit 114 is shown in FIG. 13 which includes multiple alternative panels 60.

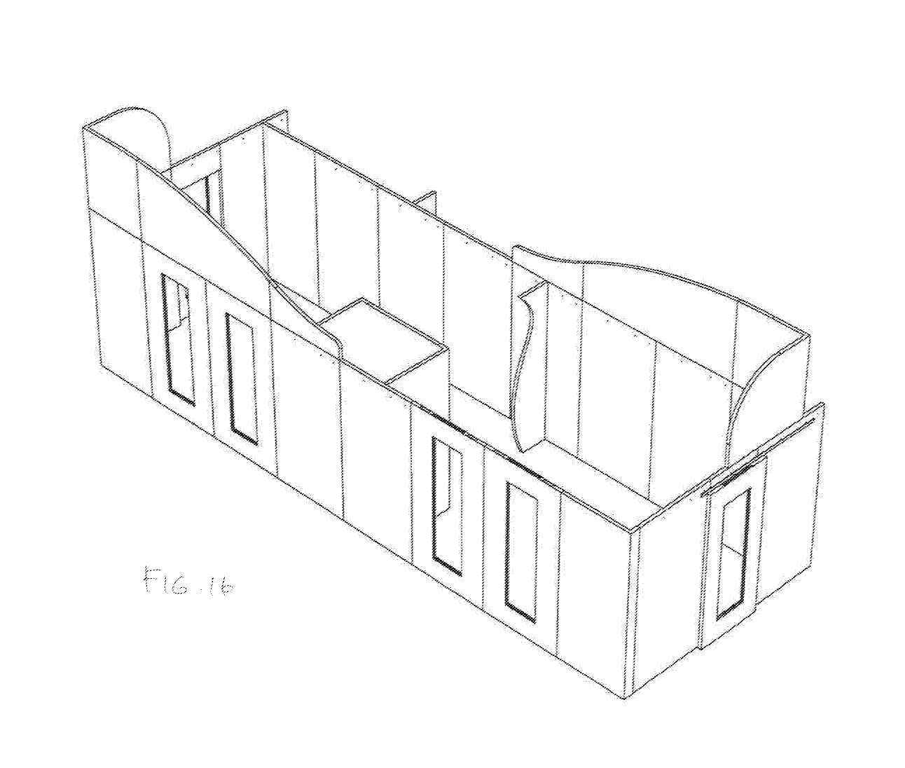

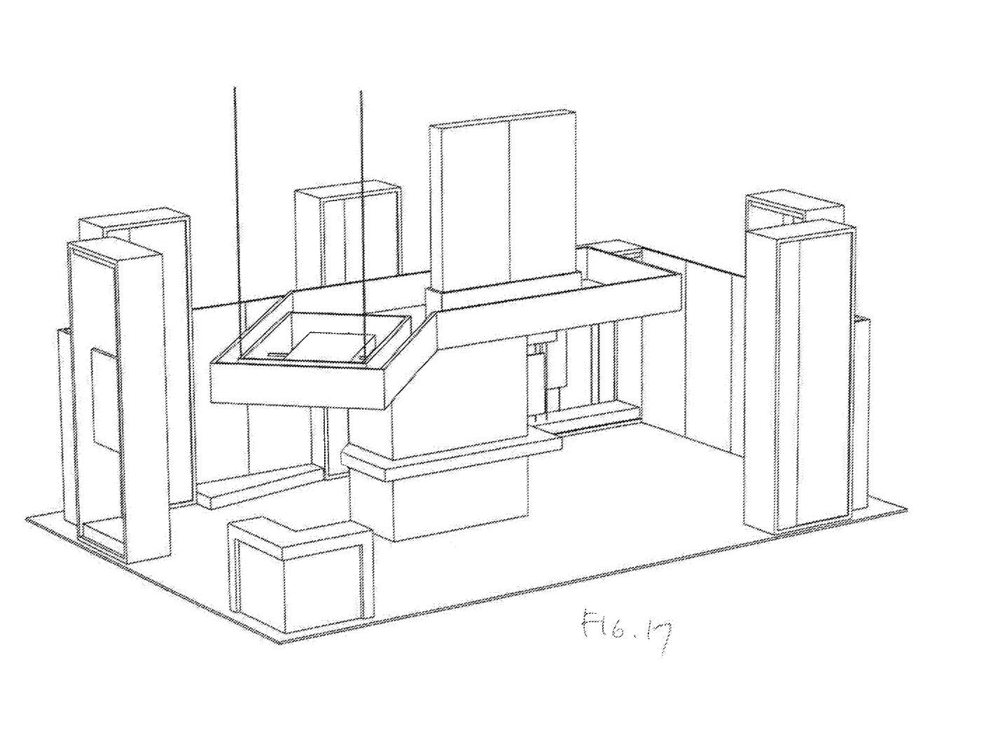

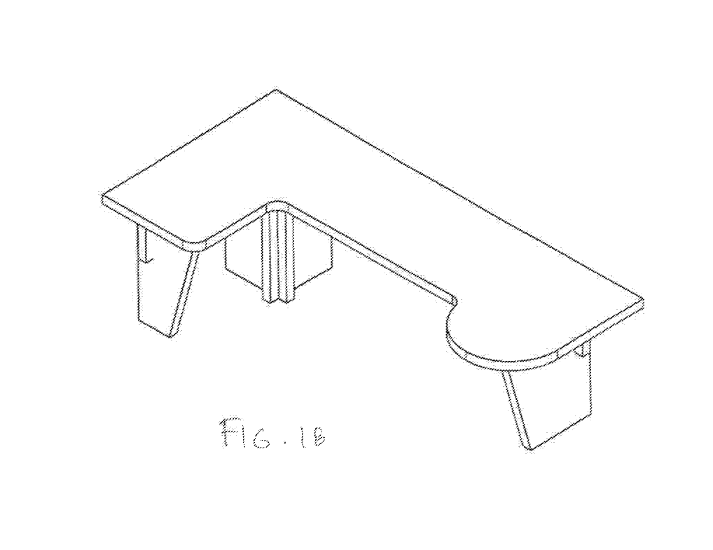

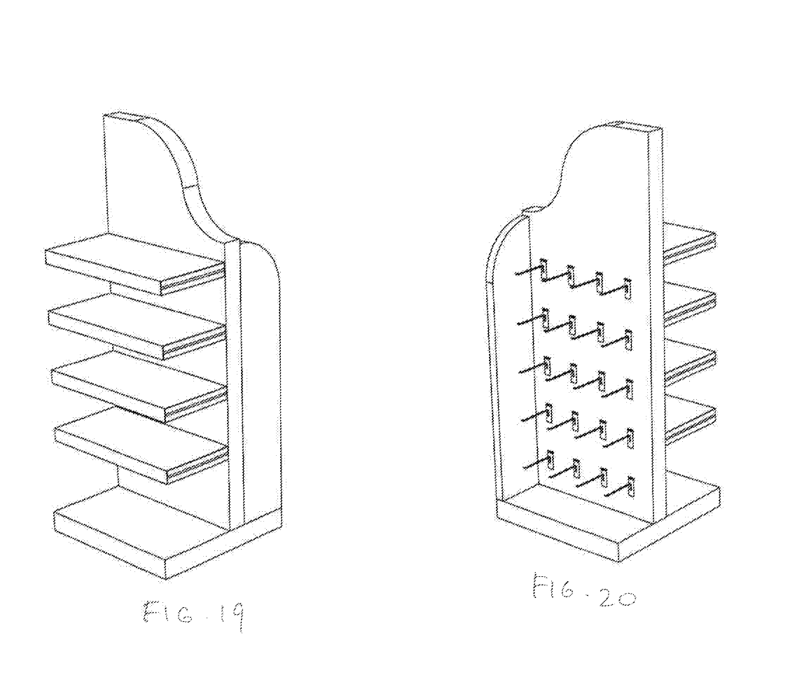

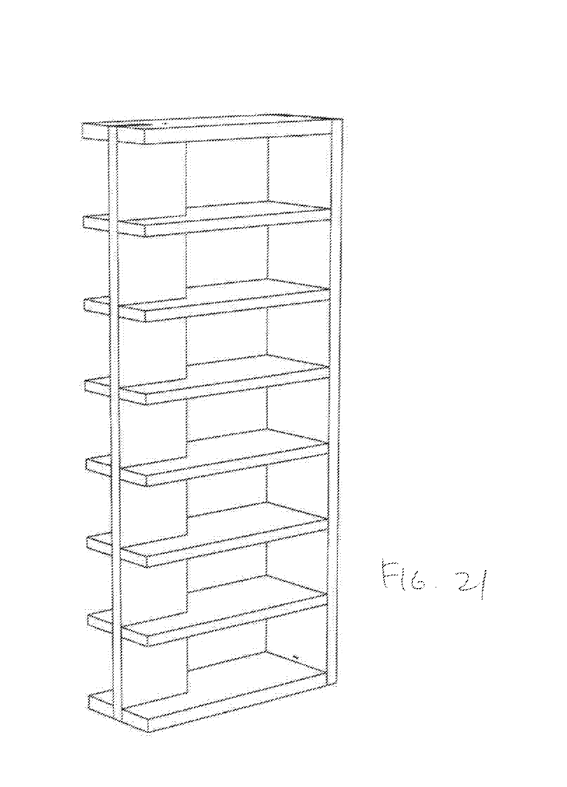

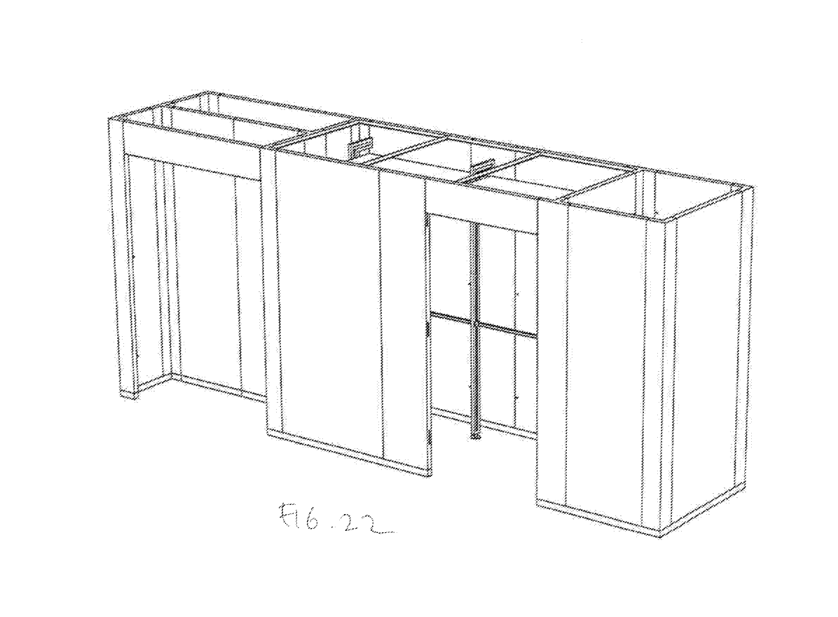

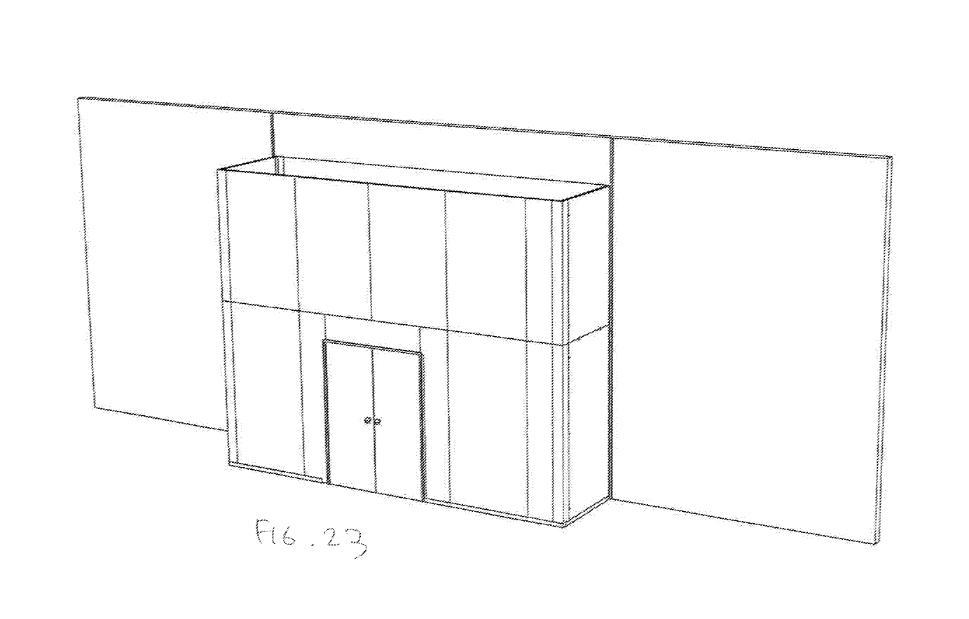

The panels can be used for many purposes, just a few of which being illustrated in FIGS. 14-21. When a panel is to be used for long term or outdoor installations, it will be surface laminated with suitable material such as ABS, HPL.

Whereas in FIGS. 2-4 the lock is fitted into the panel prior to the application of edge banding, the locks can also be inserted post banding, for example, by milling a cavity through the edge banding and into the corrugation and gluing the locks in the cavity with PUR.

Accordingly, the invention should be understood to be limited only by the accompanying claims, purposively construed.

What is claimed is:

1. A construct comprising:
a plurality of corrugated panels, the plurality including a pair of panels, each of the panels having a planar surface surrounded by an outer edge,
one of the pair of panels defining a void in which a female component of a coffin lock is situated, the female component defining a cavity with a pin extending thereacross, the cavity presenting outwardly from the one of the pair of panels; and
the other of the pair of panels defining another void at the outer edge of the other of the pair of panels in which a male component is situated, the male component defining another cavity presenting outwardly from the outer edge of the other of the pair of panels, the other cavity having a hook extending therefrom and protruding from the outer edge,
wherein the hook of the male component is releasably engaged with the pin of the female component, thereby locking the pair of panels together.

2. The construct of claim 1, wherein each of the plurality of panels further comprises edge banding at the outer edge, the edge banding defining an aperture in communication with the respective cavity of the male or female component when the respective cavity is presenting outwardly from the outer edge.

3. The construct of claim 2, wherein the cavity of the female component presents outwardly from the outer edge of the one of the pair of panels, such that the panels in the pair are locked together generally to form a common plane.

4. The construct of claim 2, wherein the cavity of the female component presents outwardly from the planar surface of the one of the pair of panels, such that the panels in the pair are locked together generally at an angle.

5. The construct of claim 2, wherein each of the plurality of panels comprises a honeycomb layer flanked by a pair of corrugated layers.

6. The construct of claim 4, wherein the other void is defined within the honeycomb layer extending between the corrugated layers in the other of the pair of panels.

7. The construct of claim 6, wherein the honeycomb layer is generally 1⅛ inches thick and each of the pair of corrugated layers is generally ⅜ inches thick.

8. The construct of claim 1, wherein the male and female components each define an aperture, the apertures being situated on the respective component to be complementary to one another, the construct further comprising an alignment pin received through the apertures, the alignment pin for guiding the male and female components into alignment prior to locking the pair of panels together.

9. The construct of claim 1, wherein the plurality of panels defines temporary hoarding.

10. The construct of claim 1, wherein the plurality of panels defines walls of a trade show booth.

11. The construct of claim 1, wherein the plurality of panels defines retail displays.

12. A kit comprising:
a plurality of corrugated panels, the plurality including a pair of panels, each of the panels having a planar surface surrounded by an outer edge,
one of the pair of panels defining a void in which a female component of a coffin lock is situated, the female component defining a cavity with a pin extending thereacross, the cavity presenting outwardly from the one of the pair of panels; and
the other of the pair of panels defining another void at the outer edge of the other of the pair of panels in which a male component is situated, the male component defining another cavity presenting outwardly from the outer edge of the other of the pair of panels, the other cavity having a hook extendable therefrom for releasably engaging with the pin of the female component and locking the pair of panels together.

13. The kit of claim 12, wherein each of the plurality of panels further comprises edge banding at the outer edge, the edge banding defining an aperture in communication with the respective cavity of the male or female component when the respective cavity is presenting outwardly from the outer edge.

14. The kit of claim 13, wherein the cavity of the female component presents outwardly from the outer edge of the one of the pair of panels.

15. The kit of claim 13, wherein the cavity of the female component presents outwardly from the planar surface of the one of the pair of panels.

16. The kit of claim 13, wherein each of the plurality of panels comprises a honeycomb layer flanked by a pair of corrugated layers.

17. The kit of claim 16, wherein the other void is defined within the honeycomb layer extending between the corrugated layers in the other of the pair of panels.

18. The kit of claim 17, wherein the honeycomb layer is generally 1⅛ inches thick and each of the pair of corrugated layers is generally ⅜ inches thick.

19. The kit of claim 12, further comprising an alignment pin, wherein the male and female components each define an aperture:
situated on the respective component to be complementary to one another, and
configured to receive the alignment pin,
the alignment pin for guiding the male and female components into alignment prior to locking the pair of panels together.

20. A panel comprising:
a corrugated body having a planar surface surrounded by an outer edge,
a female component of a coffin lock secured within a void in the corrugated body, the female component defining a cavity with a pin extending thereacross, the cavity presenting outwardly from the corrugated body, and
a male component of the coffin lock secured within another void in the corrugated body, the male component defining another cavity presenting outwardly from the outer edge of the corrugated body, the other cavity having a hook extendable therefrom for releasably engaging with another pin of another female component.
